(19) United States
(12) Patent Application Publication
(10) Pub. No.: US 2022/0413903 A1
(43) Pub. Date: Dec. 29, 2022

(54) FRAMEWORK FOR MIGRATING APPLICATIONS ACROSS PUBLIC AND PRIVATE CLOUDS

(71) Applicant: Oracle International Corporation, Redwood Shores, CA (US)

(72) Inventors: Harshit Kumar Kalley, Sunnyvale, CA (US); Merrick Walter Schincariol, Almonte (CA); Bhavesh Purushottam Davda, Fremont, CA (US); Srikanth Vavilapalli, Dublin, CA (US); Jeffrey Pleau, Carleton Place (CA)

(73) Assignee: Oracle International Corporation, Redwood Shores, CA (US)

(21) Appl. No.: 17/566,842

(22) Filed: Dec. 31, 2021

Related U.S. Application Data
(60) Provisional application No. 63/216,316, filed on Jun. 29, 2021.

(51) Int. Cl. G06F 9/48; H04L 9/40; H04L 9/08; G06F 8/60; H04L 9/32

(52) U.S. Cl. CPC G06F 9/4862; H04L 63/08; H04L 9/0825; G06F 8/60; H04L 9/0894; H04L 9/3226

(57) ABSTRACT

Discussed herein are techniques for migrating an application from a source cloud environment (SCE) to a target cloud environment (TCE). Responsive to a request received by an application migration service (AMS) to migrate an application executed in a first compute instance in the SCE to a second compute instance in the TCE, the AMS authenticates credentials of a user with respect to the SCE. Upon the credentials being successfully authenticated, the AMS generates a public key and a private key. The public key is transmitted to a service manager that injects the public key in the application executed in the first compute instance and the private key is assigned to a source agent. The source agent obtains one or more artifacts and configuration information that enable execution of the application based on the private key, which are installed by a target agent in the second compute instance in the TCE.

### CROSS-REFERENCES TO RELATED APPLICATIONS

This application is a non-provisional of and claims the benefit of the filing date of U.S. Provisional Application No. 63/216,316, filed on Jun. 29, 2021, the contents of which are incorporated herein by reference in its entirety for all purposes.

### FIELD

The present disclosure relates to a framework and tooling mechanism for migrating Platform as a Service (PaaS) applications across different cloud environments.

### BACKGROUND

A cloud service provider (CSP) offers multiple generations of infrastructure as a service (IaaS) including on-premise services. Newer versions of IaaS services are executed on newer, faster, secure software and hardware platforms. Customers of such IaaS services typically use platform as a service (PaaS) applications, which are run on top of IaaS. As such, customers desire to migrate applications to newer infrastructure environments to benefit from improvements in modern infrastructure.

However, traditional mechanisms of migrating applications tend to be a tedious process including a series of steps that require a large degree of user intervention e.g., analyzing service documents, learning APIs, obtaining and analyzing tooling framework, mapping the tooling framework to a version of service being used, inputting data manually, etc. Additionally, each application (e.g., PaaS application) is different and may have nested dependencies on other services. As such, the migration process for each application is also different. Consequently, the CSP cannot consolidate customers on the modern infrastructure in a seamless manner.

Embodiments described herein address these and other issues related to migrating applications between different cloud environments.

### BRIEF SUMMARY

The present disclosure relates generally to a framework for migrating applications (e.g., PaaS applications) from a source cloud environment to a target cloud environment. Various embodiments are described herein, including methods, systems, non-transitory computer-readable storage media storing programs, code, or instructions executable by one or more processors, and the like. These illustrative embodiments are mentioned not to limit or define the disclosure, but to provide examples to aid understanding thereof. Additional embodiments are discussed in the detailed description section, and further description is provided therein.

One embodiment of the present disclosure is directed to a method comprising: responsive to a request received by an application migration service (AMS) to migrate an application executed in a first compute instance in a source cloud environment to a second compute instance in a target cloud environment, authenticating by the AMS, credentials of a user with respect to the source cloud environment; and responsive to the credentials of the user being successfully authenticated: generating, by the AMS, a pair of keys including a public key and a private key; transmitting, by the AMS, the public key to a service manager, the service manager being configured for injecting the public key in the application executed in the first compute instance of the source cloud environment; assigning, by the AMS, the private key to a source agent deployed in the source cloud environment; obtaining, by the source agent, one or more artifacts and configuration information that enable execution of the application based on the private key; and installing, by a target agent deployed in the target cloud environment, the one or more artifacts and the configuration information in the second compute instance.

Another aspect of the present disclosure provides for a computing device comprising a processor; and a memory including instructions that, when executed with the processor, cause the computing device to, at least: responsive to a request received by an application migration service (AMS) to migrate an application executed in a first compute instance in a source cloud environment to a second compute instance in a target cloud environment, authenticate by the AMS, credentials of a user with respect to the source cloud environment; and responsive to the credentials of the user being successfully authenticated: generate, by the AMS, a pair of keys including a public key and a private key; transmit, by the AMS, the public key to a service manager, the service manager being configured for injecting the public key in the application executed in the first compute instance of the source cloud environment; assign, by the AMS, the private key to a source agent deployed in the source cloud environment; obtain, by the source agent, one or more artifacts and configuration information that enable execution of the application based on the private key; and install, by a target agent deployed in the target cloud environment, the one or more artifacts and the configuration information in the second compute instance.

Another aspect of the present disclosure provides a computer readable medium storing specific computer-executable instructions that, when executed by a processor, cause a computer system to at least: responsive to a request received by an application migration service (AMS) to migrate an application executed in a first compute instance in a source cloud environment to a second compute instance in a target cloud environment, authenticate by the AMS, credentials of a user with respect to the source cloud environment; and responsive to the credentials of the user being successfully authenticated: generate, by the AMS, a pair of keys including a public key and a private key; transmit, by the AMS, the public key to a service manager, the service manager being configured for injecting the public key in the application executed in the first compute instance of the source cloud environment; assign, by the AMS, the private key to a source agent deployed in the source cloud environment; obtain, by the source agent, one or more artifacts and configuration information that enable execution of the application based on the private key; and install, by a target agent deployed in the target cloud environment, the one or more artifacts and the configuration information in the second compute instance.

The foregoing, together with other features and embodiments will become more apparent upon referring to the following specification, claims, and accompanying drawings.

### BRIEF DESCRIPTION OF THE DRAWINGS

FIG. 1 depicts an exemplary architecture of an application migration service (AMS) in accordance with various embodiments.

FIG. 2 depicts a flow diagram illustrating a process of authorizing credentials of a user with respect to a source cloud environment in accordance with various embodiments.

FIG. 3A depicts a flow diagram illustrating a migration process in accordance with various embodiments.

FIG. 3B depicts a flow diagram illustrating a migration process in accordance with certain embodiments.

FIG. 4A depicts a flowchart illustrating an exemplary process performed by an application migration service with respect to a source cloud environment in accordance with some embodiments.

FIG. 4B depicts a flowchart illustrating an exemplary process performed by an application migration service with respect to a target cloud environment in accordance with some embodiments.

FIG. 5 is a block diagram illustrating one pattern for implementing a cloud infrastructure as a service system, according to at least one embodiment.

FIG. 6 is a block diagram illustrating another pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Application migration service (AMS) is a service provided by a cloud infrastructure service provider that allows customers to migrate applications e.g., Platform as a Service (PaaS) applications from a source cloud environment to a target cloud environment. An application is a combination of deployable artifacts (e.g., binaries) and the applied application configuration information that enable execution of the application. Migration is defined herein as a process of transferring the application binaries and configuration information (as opposed to migrating an entire virtual machine or database) from an application instance (e.g., a compute instance such as a virtual machine) running in the source cloud environment to a target cloud environment. For sake of illustration, details of the migration process described herein reference migrating a PaaS application. However, it is noted that the migration framework described herein is equally applicable to migrate other types of applications.

The source cloud environment includes a service tenancy and a customer tenancy. A PaaS application is executed in the customer tenancy (i.e., the application is executed in a compute instance e.g., a virtual machine or a container hosted in the customer tenancy) of the source cloud environment. The service tenancy includes a control plane hosting a source agent that is configured to extract application binaries and corresponding application configuration information from the source environment. The extracted information is deployed in the target cloud environment. As will be described herein, migration is facilitated by the source agent in the source cloud environment and a target agent associated with the target cloud environment.

The target cloud environment also includes a service tenancy and a customer tenancy. The target agent is deployed in the service tenancy of the target cloud environment and isolates a control plane of the service tenancy from a customer tenancy of the target cloud environment. In order to migrate the PaaS application, the control plane of the target cloud environment instantiates a new VM or container in the customer tenancy of the target cloud environment to host the PaaS application. The target agent in the target cloud environment obtains, from the source agent in the source cloud environment, information (i.e., application configuration and binaries) related to the PaaS application that is being executed in the source cloud environment. Upon obtaining the information, the target agent installs the application binaries and corresponding application configuration information in the newly instantiated VM or container in the target cloud environment. Thus, according to some embodiments, the migration process includes at least the following steps of: (a) setting a trust between the source cloud environment and target cloud environment, (b) selecting a source agent from a service tenancy of the source cloud environment, (c) discovering one or more PaaS applications being executed in the customer tenancy of the source cloud environment, (d) copying by the source agent, the configuration information and binaries associated with the one or more discovered PaaS applications, (e) instantiating a new instance of a VM/container in the customer tenancy of the target cloud environment, and (f) installing, by the target agent, the configuration information and binaries in the newly instantiated VM/container.

According to some embodiments, AMS includes several distinct components defined herein as follows:

Source Instance: The PaaS service instance owned by the customer running in their source cloud environment tenancy.
Target Instance: The PaaS service instance owned by the customer running their target cloud environment tenancy. This instance may be created as part of the migration process.
Target Service Tenancy: A tenancy that exists in each target production region hosting the AMS control plane, APIs, and workflows. It also hosts the target agent instances that deploy applications onto the customer target instances. The agents can be remotely managed by workflows running in the control plane.
Source Service Tenancy: A tenancy that exists in each source zone for the purpose of hosting the source agent responsible for interacting with the source instance running in the source customer tenancy.
Source Agent: A micro service running in the source service tenancy that discovers details about customer applications and accesses the source instance to export artifacts as part of the migration process. The source agent API is stateless and idempotent. Any step of the migration on the source agent can be retried without need for cleanup and does not incur any customer downtime unless they voluntarily choose to do so.
Target Agent: A micro service running in the target service tenancy that attaches to the subnet hosting the target instance and facilitates the deployment of application artifacts as part of the migration process. The target agent API is stateless and idempotent. By some embodiments, the source agent and the target agent (i.e., the micro services) are processing units that can be implemented in software, hardware, or a combination of software and hardware modules.

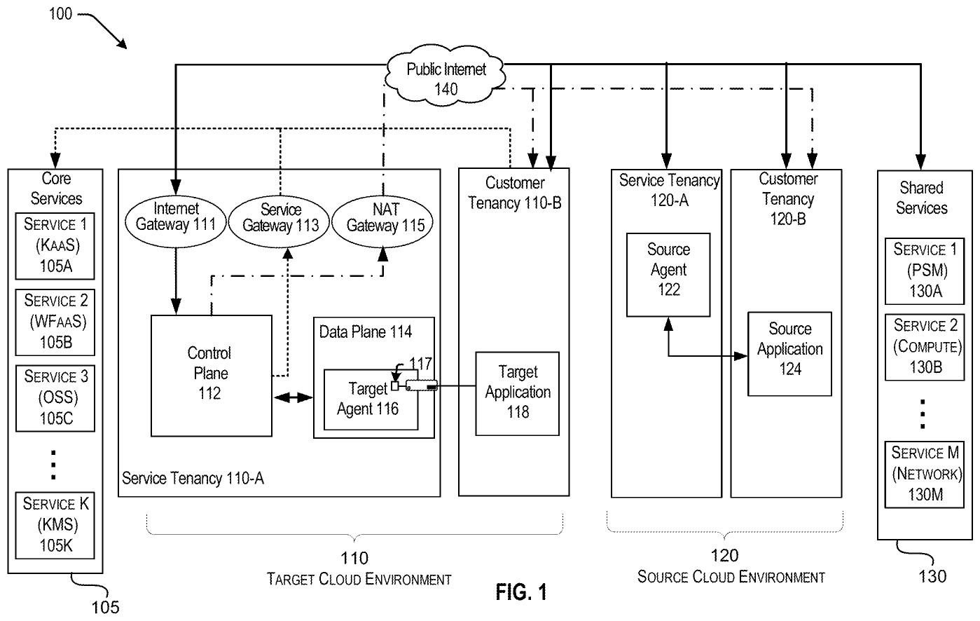

FIG. 1 depicts an exemplary architecture of an application migration service (AMS) in accordance with various embodiments. As shown in FIG. 1, the AMS architecture 100 includes a target cloud environment 110, a source cloud environment 120, a set of core services 105 provided by the target cloud environment, and a set of shared services 130 utilized by both, the source cloud environment 120 and the target cloud environment 110. The source cloud environment 120 and the target cloud environment 110 are commutatively coupled via the public internet 140.

The source cloud environment 120 includes a service tenancy 120-A and a customer tenancy 120-B. A source agent 122 is deployed in the service tenancy 120-A of the source cloud environment 120 and configured to extract binaries and application configuration information of a PaaS application (i.e., a source application 124) being executed in a VM/container deployed in the customer tenancy 120-B of the source cloud environment 120.

The target cloud environment 110 includes a service tenancy 110-A and a customer tenancy 110-B. The service tenancy 110-A includes a separated control plane 112 and a data plane 114. According to some embodiments, the control plane 112 is a java based drop wizard service and includes a plurality of API servers and a plurality of workers as two main sub-systems. The API servers provide customer facing REST APIs to perform CRUD operations of AMS service resources. The worker subsystem is responsible for implementing long running migration tasks using core services 105 e.g., WFaaS (Workflow as a Service i.e., service 2 105B) framework.

The data plane 114 included in the service tenancy 110-A of the target cloud environment 110 includes a fleet of target agents 116 that perform operations such as creating target PaaS instances and importing application artifacts into newly created application instances. A data plane in the service tenancy 120-A of the source cloud environment 120 includes a fleet of source AMS agents 122. The source agents perform operations such as deep discovery and export of existing application artifacts to an object storage i.e., a database. The target agent 116 deployed in the service tenancy 110-A of the target cloud environment 110 utilizes a virtual network interface card (VNIC) 117 to deploy application artifacts and configuration information within a target application 118 instantiated in the customer tenancy 110-B of the target cloud environment 110. By some embodiments, the control plane 112 of the service tenancy 110-A is configured to instantiate a new VM or container in the customer tenancy 110-B of the target cloud environment 110 to host the PaaS application.

According to some embodiments, the AMS provides two high level resource abstractions:
Source (i.e., migration source): represents source environment from which the migration of an application is to be initiated.
Migration: represents migration of an application from source environment to target environment.

Operations permitted on AMS resources include at least the following:
Create Source: Creates a source object in a database (DB) and validates if the user has necessary privileges to access the source environment.
List applications: Once a source is successfully created (authenticated in source environment), user is allowed to view all applications running in that source environment.
Update Source: Updates a source object with new user credentials or any other mutable parameters (like tags, display name . . . etc).
Delete Source: Deletes a source object.
Create Migration: Create a migration object in DB and perform a discovery of source application configuration.
Update Migration: Updates a migration object with target specific configuration parameters (like target VCN subnet, target availability domain . . . etc).
Start Migration: Starts the actual migration of application from source cloud environment to target cloud environment.
Delete Migration: Deletes a migration object.

By some embodiments, a ‘source’ can be in one of the following states: creating, inactive, active, updating, and deleting. A migration resource can be in one of the following states: Creating/Discovering, Missing_Config, Ready, Updating, Migrating, Migration_Success, Migration_Failed, and Deleting. According to some embodiments, AMS supports migrations of the following types of PaaS applications: java cloud service (JCS), integration cloud service (ICS), analytic cloud service (ACS), SOA cloud service (SOACS), and internal compute ICS. Further, as shown in FIG. 1, the target cloud environment 110 is communicatively coupled to the source cloud environment 120, the set of core services 105, and the set of shared services 130 by the public Internet 140 via the internet gateway 111, service gateway 113, and NAT gateway 115, respectively. Moreover, it is appreciated that the AMS as described herein is capable of migrating a PaaS application (i.e., application binaries and configuration information) from any zone/region of a source cloud environment to any zone or region in the target cloud environment.

As shown in FIG. 1, AMS interfaces with with different target cloud environment services (i.e., core services) 105 and shared services 130 as part of providing migration services. For instance, the core services 105 include a plurality of services i.e., service 1 (KaaS) 105A, service 2 (WFaaS) 105B, service 3 (OSS) 105C, and service K (KMS) 105K, whereas the shared services 130 include a set of services such as service 1 (PSM) 130A, service 2 (Compute) 130B, and service M (network) 130M. The services included in the core services 105 and the shared services 130 are described below.
KaaS (Key/Value as a Service)
   AMS stores all its persistent state in regional KaaS either in plain or encrypted format
   The communication between AMS API and Worker subsystems is via KaaS
WFaaS (Workflow as a Service)
   AMS worker subsystem uses WFaaS to launch long running workflow for each work request received from API subsystem
Target Cloud Compute
   AMS discovers the fleet of AMS target agents using this interface
   AMS attaches secondary vNIC using this interface to the target agents. The secondary VNIC is from the same customer VCN/subnet where the target PaaS instance is going to be created.
Object Storage
   AMS uses object storage to store the migration artifacts (application archives . . . etc) until migration completes
   AMS also uses object storage for seeding the customer data (such as identity stripe mapping and customer's ssh key pair) into AMS data store
KMS (Key Management Service)
   AMS uses KMS to encrypt all customer sensitive data (passwords, keys . . . etc) before persisting in the KaaS
PSM (Platform Service Manager)
   AMS interfaces with PSM to fetch the source environment details of an application
   On the target side, for PSM based migrations, AMS uses PSM to create target PaaS instances
Source Cloud Compute
   AMS discovers the fleet of AMS source agents running in source cloud environments using this interface

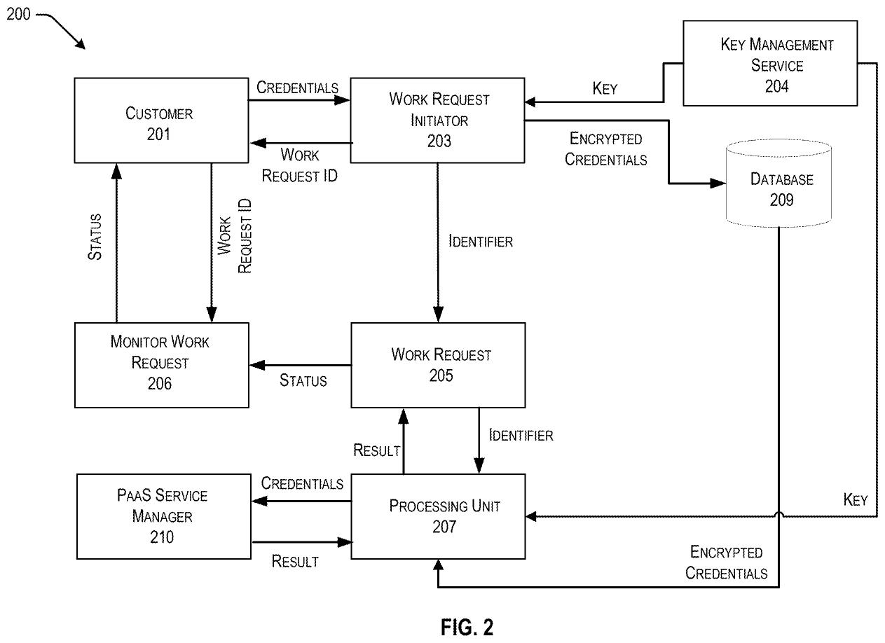

In what follows, there is provided a detailed description of the migration service provided by the AMS, and the interactions of the AMS with the source cloud environment and the target cloud environment. By some embodiments, when the control plane of the target cloud environment receives a request (from a customer) to migrate an application that is being executed in the source cloud environment, the control plane (e.g., control plane 112) triggers the AMS service to execute the migration process. As described next with reference to FIG. 2, as a first step of the migration process, the AMS service authorizes credentials of the user with respect to the source cloud environment i.e., the AMS service determines whether the user has a valid account (and a sufficient level of privilege to issue migration requests) in the source cloud environment.

FIG. 2 depicts a flow diagram 200 illustrating a process of authorizing a source in accordance with various embodiments. Specifically, a request for migrating a PaaS application that is initiated by a customer is received by the AMS (e.g., control plane included in a service tenancy of the target cloud environment). By some embodiments, the AMS utilizes a PaaS service manager (PSM) to verify customer credentials (i.e., whether the customer has access to a particular source cloud environment from which an application is to be migrated) and to determine whether the customer has sufficient privileges (e.g., administrative rights) in the source cloud environment to initiate the migration process.

According to some embodiments, a customer 201 utilizes an API to interact with the AMS and provides credentials (e.g., username and password) associated with a customer account in the source cloud environment. The credentials provided by the customer 201 are received by a work request initiator 203. The work request initiator 203 utilizes a key obtained from a key management service (KMS) 204 to encrypt the credentials and store the encrypted credentials in a key-value database e.g., database 209.

Upon storing the customer's encrypted credentials, the work request initiator 203 generates an identifier that is associated with the customer's request and generates an asynchronous work request 205 based on the generated identifier. Additionally, the customer 201 is provided with a work request ID, which the customer may use to monitor a status of of the authorization process (e.g., via a monitor work request API 206).

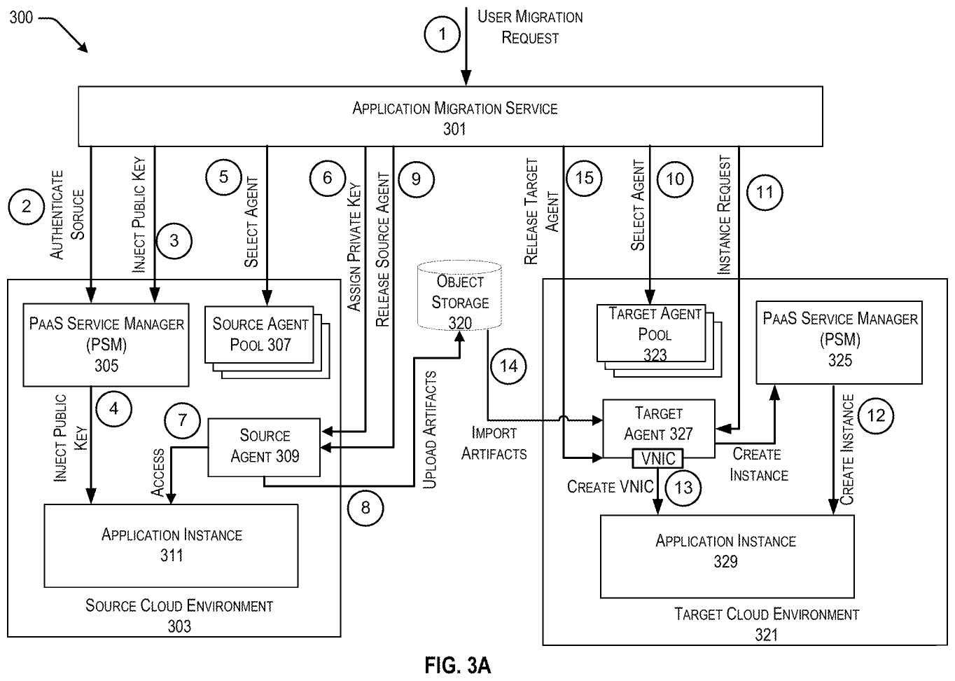

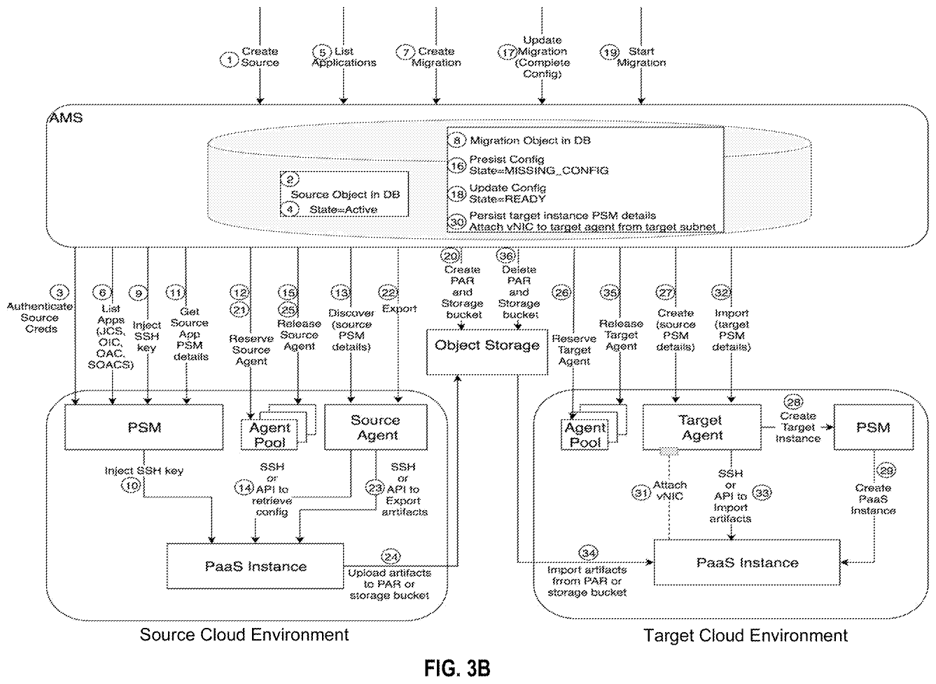

A processing unit 207 utilizes the identifier to retrieve the stored encrypted credentials (associated with the customer) from the key-value database e.g., database 209. The processing unit 207 also retrieves the corresponding key (used to encrypt the customer credentials) from the KMS 204. The retrieved key is utilized to decrypt the encrypted customer credentials obtained from the database 209. The decrypted credentials are utilized by the PSM 210 to determine, at least, whether the customer has a valid account associated with the source cloud environment, and a level of privilege e.g., administrative rights, etc., associated with the customer's account. The PSM 210 verifies the customer's credentials and transmits a result back to the AMS. Upon the customer being successfully validated, the AMS further processes the migration request as described next with reference to FIG. 3A.

Turning to FIG. 3A, there is depicted a flow diagram illustrating a migration process in accordance with various embodiments. As shown in FIG. 3A, an application migration service (i.e., AMS) 301 communicates with a source cloud environment 303 and a target cloud environment 321 to migrate an application executed in an application instance in the source cloud environment 303 to an application instance in the target cloud environment 321. Further, as shown in FIG. 3A, the source cloud environment 303 includes a PaaS service manager 305, a pool of source agents 307 (from which a source agent 309 is selected for performing the migration), and an application instance 311 in which the application to be migrated in being executed. It is noted that the application instance 311 may correspond to a virtual machine or a container that hosts the application. The target cloud environment 321 includes a pool of target agents 323 (from which a target agent 327 is selected for performing the migration), a PaaS service manager 325, and an application instance 329, which will host the migrated application. Further, it is appreciated that even though PSM is depicted as two different entities (i.e., 305 and 325) running in the source cloud environment and target cloud environment, the PSM can be a single geo-level entity having access both the source and target cloud environments.

The steps of the migration process are described below with reference to the numerals included in each step as depicted in FIG. 3A. In step 1, the AMS receives a migration request from a user/customer. The migration requests indicates an application executed in an instance in the source cloud environment that is to be migrated to another application instance in the target cloud environment. In step 2, the AMS invokes the PSM running in the source cloud environment to authenticate credentials of the user with respect to the source cloud environment. Specifically, the AMS utilizes the PSM to verify whether the user has a valid account associated with the source cloud environment, and also verify whether the user has sufficient privileges to initiate a PaaS application migration request. Details pertaining to the authorization of user credentials are described above with reference to FIG. 2.

Upon the credentials of the user being successfully validated, the AMS generates a key pair including a public key and a private key. By some embodiments, the generated key pair is ephemeral in nature i.e., the key pair is valid for a short time-duration (e.g., an amount of time corresponding to an estimated time required for completion of the PaaS application migration process) and is associated uniquely with the migration request. The public key is injected by the AMS in to the PSM in step 3.

In step 4, the PSM injects the public key in the PaaS application instance running in the source cloud environment. According to some embodiments, the process of injecting a key in an instance of application corresponds to storing the key in an authorized key file associated with the application. In step 5, the AMS reserves/selects an available source agent from the pool of source agents to enable the migration process. In step 6, the AMS assigns the private key (of the generated key pair) to the selected source agent of step 4. In step 7, the source agent utilizes one or more plugins (i.e., software modules/components deployed in the source agent) to access and retrieve information pertaining to the PaaS application from the application instance. The information pertaining to the PaaS application can correspond to one or more artifacts (e.g., application binaries) and application configuration information that enable execution of the application. In step 8, the source agent uploads the retrieved information to an object storage. Upon the retrieved information being stored in the object storage, the AMS in step 9 releases the source agent to the pool of source agents to be used for subsequent migration requests. By some embodiments, the AMS performs a clean-up process with respect to source agent, where the private key assigned to the source agent (in step 6) is deleted, prior to the source agent being released to the pool of source agents.

In step 10, the AMS reserves a target agent from a pool of target agents in the target cloud environment. In step 11, the AMS transmits a request to the selected target agent to create a new virtual machine or container i.e., an application instance, in the customer tenancy of the target cloud environment to host the PaaS application. The target agent utilizes the PSM running in the target cloud environment to create (i.e., instantiate) an application instance in the target cloud environment (step 12).

In step 13, the AMS creates a VNIC (i.e., a virtual network interface card) that is attached to (associated with) the target agent selected/reserved in step 10. The VNIC is used as a means for the target agent to communicate with the application instance created in the target cloud environment. In step 14, the target agent obtains the information (i.e., application binaries and configuration information of the PaaS application) stored in the database (e.g., an encrypted database) by the source agent, and deploys (i.e., installs) the obtained information within the application instance created in the customer tenancy via the VNIC. Upon deploying the application binaries and configuration information in the target application instance, the AMS in step 15, releases the target agent to the pool of target agents to be used for subsequent migration requests.

FIG. 3B depicts according to another embodiment, a flow diagram illustrating data flow in a migration process. It is appreciated that even though PSM is depicted as two different entities running in the source cloud environment and target cloud environment in FIG. 3B, the PSM can be a single geo-level entity having access both the source and target cloud environments. The steps of migration are described next with reference to the numerals included in each step depicted in FIG. 3B. The steps are as follows:
1. User invokes Create Source REST API
2. Source object is created in KaaS DB
3. Authenticate Source credentials with PSM
4. Once Source is Authenticated, set the state as ACTIVE
5. User invokes List Applications REST API
6. AMS invokes PSM list instances APIs for all supported application type to shallow discover all applications running in source cloud environment
7. User invokes Create Migration REST API for one of the application in the source cloud environment
8. Migration object is created in KaaS DB
9. For JCS, OAC and SOACS migration types, AMS generates a ssh key pair and invokes PSM API to inject public key into source application
10. PSM injects the public key in to source application
11. AMS invokes PSM REST API to get source application details
12. AMS reserves an available source AMS agent from the pool associated with source cloud environment
13. AMS invokes DISCOVER API of AMS agent by providing source application PSM details
14. Source agent either SSH into source application (for JCS, OAC, SOACS) or invokes public API of source application to discover the source application configuration and return to AMS control plane
15. AMS releases source AMS agent back to the pool
16. AMS persists the discovered configuration in the migration object and set the state to MISSING_CONFIG (indicates user need to provide the configuration related target environment)
17. User invokes Update Migration REST API to provide the missing configuration for the migration
18. AMS updates the configuration and set the state to READY
19. User invokes Start Migration REST API
20. AMS creates PAR (Pre-Authenticate Resource) link and Storage bucket in Object Storage
21. AMS reserves an available source AMS agent from the pool associated with source cloud environment
22. AMS invokes EXPORT API of AMS agent by providing source application PSM details
23. Source agent either SSH into source application (for JCS, OAC, SOACS) or invokes public
API of source application to start export process for the source application artifacts
24. The source application artifacts are uploaded to specified PAR link or storage bucket
25. AMS releases source AMS agent back to the pool
26. AMS reserves an available target agent from the pool associated with target cloud environment
27. AMS invokes CREATE_TARGET_INSTANCE API of target agent by providing source application PSM details
28. Target agent invokes PSM API to launch target PaaS instance in target cloud environment
29. PSM creates target PaaS instance in target cloud environment
30. Target agent returns the PSM details of target PaaS instance to Control plane which is persisted in migration object
31. AMS creates a vNIC (for JCS, SOACS) from subnet in which target PaaS instance was launched and attaches to target agent
32. AMS invokes IMPORT API of target agent by providing target application PSM details
33. Target agent either SSH into target application (for JCS, SOACS) or invokes public API of source application (for OIC, ICS, PCS, OAC) to start import process into the target application
34. Artifacts are imported using specified PAR link or storage bucket from Object storage into target application
35. AMS releases target AMS agent back to the pool
36. AMS deletes PAR links and storage bucket resources

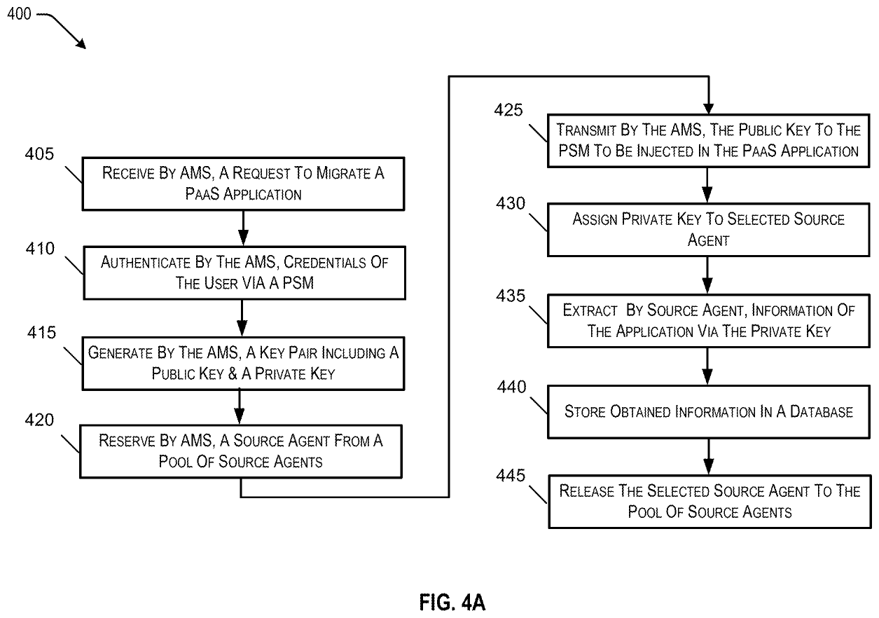

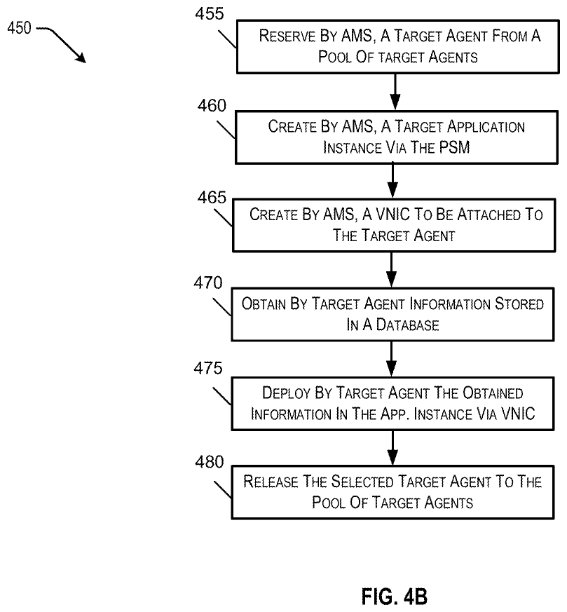

FIG. 4A depicts a flowchart illustrating an exemplary process 400 performed by an application migration service with respect to a source cloud environment in accordance with some embodiments. The processing depicted in FIG. 4A may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 4A and described below is intended to be illustrative and non-limiting. Although FIG. 4A depicts the various processing steps occurring in a particular sequence or order, this is not intended to be limiting. In certain alternative embodiments, the steps may be performed in some different order or some steps may also be performed in parallel.

The process commences in step 405, where the AMS receives, from a user, a request to migrate a PaaS application from a source cloud environment to a target cloud environment. It is appreciated that the PaaS application is being executed in a VM/container in a customer tenancy of the source cloud environment, and is to be migrated to a customer tenancy in the target cloud environment. The process in step 410 authenticates credentials of the user. Specifically, the AMS utilizes the PaaS service manager (PSM) to verify whether the user has a valid account associated with the source cloud environment, and also verifies whether the user has sufficient privileges to initiate a PaaS application migration request. Details pertaining to step 410 are described above with reference to FIG. 2.

In step 415, the AMS generates a key pair (e.g., an SSH key pair including a private key and a public key) to be associated with the migration request. The key pair is ephemeral i.e., the key pair is valid for a short time-duration corresponding to an amount of time required for completion of the PaaS application migration process and is associated with the migration request. In other words, each migration request is associated with a unique key pair. In step 420, the AMS reserves a source agent from a pool of source agents. The AMS transmits the public key to the PSM and assigns the private key to the selected source agent. As will be described below, via the key pair, trust is established between the AMS control plane (deployed in a target cloud environment) and the PaaS application that is running in a customer tenancy of the source cloud environment.

In step 425, the AMS transmits the public key to the PSM. The PSM injects the public key in the PaaS application instance running in the customer tenancy of the source cloud environment. According to some embodiments, the process of injecting a key in an instance of application corresponds to storing the key in an authorized key file associated with the application. The process then moves to step 430, where the AMS assigns the private key of the key pair to the selected/reserved source agent of step 420. It is noted that the pool of source agents is deployed in a service tenancy of the source cloud environment. The selected source agent is used to obtain information i.e., application binaries and configuration information of the PaaS application running in the customer tenancy of the source cloud environment.

In step 435, the reserved/selected source agent extracts information pertaining to the PaaS application i.e., artifacts (e.g., application binaries) and the application configuration information, based on the private key assigned to the source agent. For instance, the source agent can utilize one or more plugins (i.e., software modules/components deployed in the source agent) to retrieve information pertaining to the PaaS application. In step 440, the source agent stores the extracted information (of step 435) in a database. Thereafter, the process moves to step 445, where the source agent selected for the migration process is released back to the pool of source agents. By some embodiments, prior to releasing the source agent, the AMS can perform a clean-up process with respect to source agent, where the private key assigned to the source agent is deleted.

FIG. 4B depicts a flowchart illustrating an exemplary process 450 performed by an application migration service with respect to a target cloud environment in accordance with some embodiments. The processing depicted in FIG. 4B may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 4B and described below is intended to be illustrative and non-limiting. Although FIG. 4B depicts the various processing steps occurring in a particular sequence or order, this is not intended to be limiting. In certain alternative embodiments, the steps may be performed in some different order or some steps may also be performed in parallel.

The process commences in step 455, where the AMS reserves a target agent from a pool of target agents. Note that the pool of target agents is deployed in a data plane included in a service tenancy of the target cloud environment. In step 460, the AMS utilizes the PSM to create a target application instance (i.e., a virtual machine or a container in which the target application is to be executed) in a customer tenancy of the target could environment. For instance, ASM invokes an API of the target agent by providing information related to the source application. The selected target agent invokes PSM API to launch a target PaaS instance in the customer tenancy of the target cloud environment.

In step 465, the AMS creates a VNIC (i.e., a virtual network interface card) that is attached to (associated with) the target agent reserved in step 455. The process then moves to step 470, where the target agent obtains the information i.e., application binaries and configuration information of the PaaS application stored the database by the source agent (step 440 of FIG. 4A) and deploys (i.e., installs), via the VNIC, the obtained information within the application instance created in the customer tenancy (in step 460) of the target cloud environment. Upon deploying the application binaries and configuration information in the target application instance, the AMS in step 480, releases the target agent to the pool of target agents to be used for subsequent migration requests.

In the above described embodiments of FIGS. 4A and 4B, it is appreciated that the releasing of the source/target agents may include the AMS scrubbing (i.e., deleting) information from the respective agents as well as deleting the key pair that was generated to process the migration request, the VNIC associated with the target agent, etc. Furthermore, it is appreciated that the steps as depicted in FIGS. 4A and 4B are intended to be illustrative and non-limiting. For instance, by some embodiments, the source and target agents can be released simultaneously upon completion of the migration process or the source agent may be released prior to releasing the target agent.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different problems for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more security group rules provisioned to define how the security of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

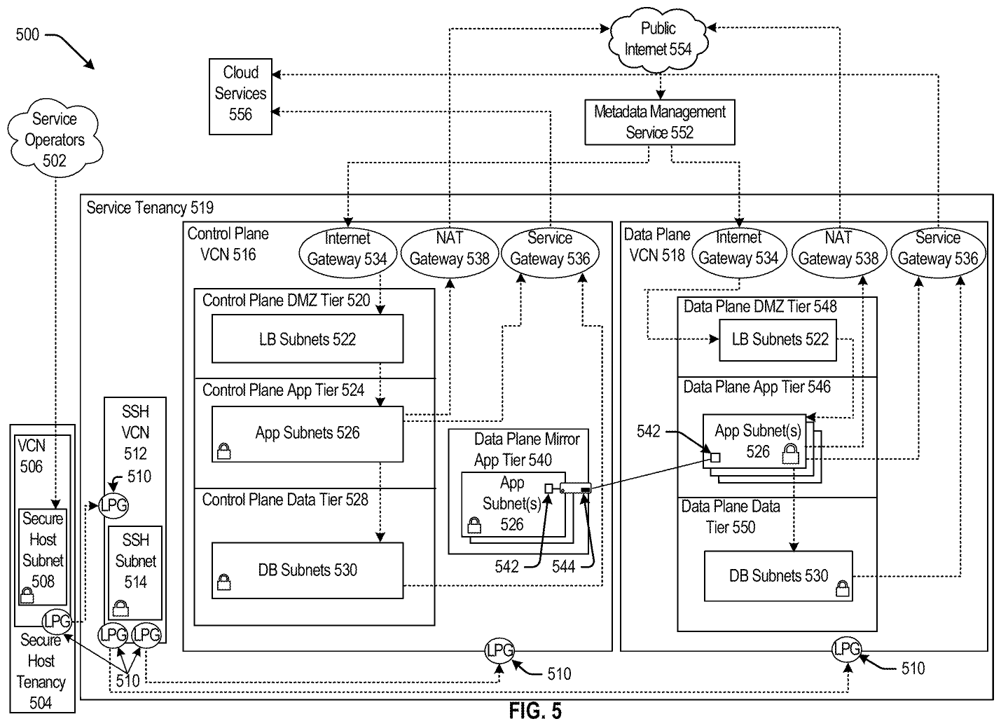

FIG. 5 is a block diagram 500 illustrating an example pattern of an IaaS architecture, according to at least one embodiment. Service operators 502 can be communicatively coupled to a secure host tenancy 504 that can include a virtual cloud network (VCN) 506 and a secure host subnet 508. In some examples, the service operators 502 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 506 and/or the Internet.

The VCN 506 can include a local peering gateway (LPG) 510 that can be communicatively coupled to a secure shell (SSH) VCN 512 via an LPG 510 contained in the SSH VCN 512. The SSH VCN 512 can include an SSH subnet 514, and the SSH VCN 512 can be communicatively coupled to a control plane VCN 516 via the LPG 510 contained in the control plane VCN 516. Also, the SSH VCN 512 can be communicatively coupled to a data plane VCN 518 via an LPG 510. The control plane VCN 516 and the data plane VCN 518 can be contained in a service tenancy 519 that can be owned and/or operated by the IaaS provider.

The control plane VCN 516 can include a control plane demilitarized zone (DMZ) tier 520 that acts as a perimeter network (e.g., portions of a corporate network between the corporate intranet and external networks). The DMZ-based servers may have restricted responsibilities and help keep security breaches contained. Additionally, the DMZ tier 520 can include one or more load balancer (LB) subnet(s) 522, a control plane app tier 524 that can include app subnet(s) 526, a control plane data tier 528 that can include database (DB) subnet(s) 530 (e.g., frontend DB subnet(s) and/or backend DB subnet(s)). The LB subnet(s) 522 contained in the control plane DMZ tier 520 can be communicatively coupled to the app subnet(s) 526 contained in the control plane app tier 524 and an Internet gateway 534 that can be contained in the control plane VCN 516, and the app subnet(s) 526 can be communicatively coupled to the DB subnet(s) 530 contained in the control plane data tier 528 and a service gateway 536 and a network address translation (NAT) gateway 538. The control plane VCN 516 can include the service gateway 536 and the NAT gateway 538.

The control plane VCN 516 can include a data plane mirror app tier 540 that can include app subnet(s) 526. The app subnet(s) 526 contained in the data plane mirror app tier 540 can include a virtual network interface controller (VNIC) 542 that can execute a compute instance 544. The compute instance 544 can communicatively couple the app subnet(s) 526 of the data plane mirror app tier 540 to app subnet(s) 526 that can be contained in a data plane app tier 546.

The data plane VCN 518 can include the data plane app tier 546, a data plane DMZ tier 548, and a data plane data tier 550. The data plane DMZ tier 548 can include LB subnet(s) 522 that can be communicatively coupled to the app subnet(s) 526 of the data plane app tier 546 and the Internet gateway 534 of the data plane VCN 518. The app subnet(s) 526 can be communicatively coupled to the service gateway 536 of the data plane VCN 518 and the NAT gateway 538 of the data plane VCN 518. The data plane data tier 550 can also include the DB subnet(s) 530 that can be communicatively coupled to the app subnet(s) 526 of the data plane app tier 546.

The Internet gateway 534 of the control plane VCN 516 and of the data plane VCN 518 can be communicatively coupled to a metadata management service 552 that can be communicatively coupled to public Internet 554. Public Internet 554 can be communicatively coupled to the NAT gateway 538 of the control plane VCN 516 and of the data plane VCN 518. The service gateway 536 of the control plane VCN 516 and of the data plane VCN 518 can be communicatively couple to cloud services 556.

In some examples, the service gateway 536 of the control plane VCN 516 or of the data plane VCN 518 can make application programming interface (API) calls to cloud services 556 without going through public Internet 554. The API calls to cloud services 556 from the service gateway 536 can be one-way: the service gateway 536 can make API calls to cloud services 556, and cloud services 556 can send requested data to the service gateway 536. But, cloud services 556 may not initiate API calls to the service gateway 536.

In some examples, the secure host tenancy 504 can be directly connected to the service tenancy 519, which may be otherwise isolated. The secure host subnet 508 can communicate with the SSH subnet 514 through an LPG 510 that may enable two-way communication over an otherwise isolated system. Connecting the secure host subnet 508 to the SSH subnet 514 may give the secure host subnet 508 access to other entities within the service tenancy 519.

The control plane VCN 516 may allow users of the service tenancy 519 to set up or otherwise provision desired resources. Desired resources provisioned in the control plane VCN 516 may be deployed or otherwise used in the data plane VCN 518. In some examples, the control plane VCN 516 can be isolated from the data plane VCN 518, and the data plane mirror app tier 540 of the control plane VCN 516 can communicate with the data plane app tier 546 of the data plane VCN 518 via VNICs 542 that can be contained in the data plane mirror app tier 540 and the data plane app tier 546.

In some examples, users of the system, or customers, can make requests, for example create, read, update, or delete (CRUD) operations, through public Internet 554 that can communicate the requests to the metadata management service 552. The metadata management service 552 can communicate the request to the control plane VCN 516 through the Internet gateway 534. The request can be received by the LB subnet(s) 522 contained in the control plane DMZ tier 520. The LB subnet(s) 522 may determine that the request is valid, and in response to this determination, the LB subnet(s) 522 can transmit the request to app subnet(s) 526 contained in the control plane app tier 524. If the request is validated and requires a call to public Internet 554, the call to public Internet 554 may be transmitted to the NAT gateway 538 that can make the call to public Internet 554. Memory that may be desired to be stored by the request can be stored in the DB subnet(s) 530.

In some examples, the data plane mirror app tier 540 can facilitate direct communication between the control plane VCN 516 and the data plane VCN 518. For example, changes, updates, or other suitable modifications to configuration may be desired to be applied to the resources contained in the data plane VCN 518. Via a VNIC 542, the control plane VCN 516 can directly communicate with, and can thereby execute the changes, updates, or other suitable modifications to configuration to, resources contained in the data plane VCN 518.

In some embodiments, the control plane VCN 516 and the data plane VCN 518 can be contained in the service tenancy 519. In this case, the user, or the customer, of the system may not own or operate either the control plane VCN 516 or the data plane VCN 518. Instead, the IaaS provider may own or operate the control plane VCN 516 and the data plane VCN 518, both of which may be contained in the service tenancy 519. This embodiment can enable isolation of networks that may prevent users or customers from interacting with other users′, or other customers′, resources. Also, this embodiment may allow users or customers of the system to store databases privately without needing to rely on public Internet 654, which may not have a desired level of security, for storage.

In other embodiments, the LB subnet(s) 522 contained in the control plane VCN 516 can be configured to receive a signal from the service gateway 536. In this embodiment, the control plane VCN 516 and the data plane VCN 518 may be configured to be called by a customer of the IaaS provider without calling public Internet 554. Customers of the IaaS provider may desire this embodiment since database(s) that the customers use may be controlled by the IaaS provider and may be stored on the service tenancy 519, which may be isolated from public Internet 554.

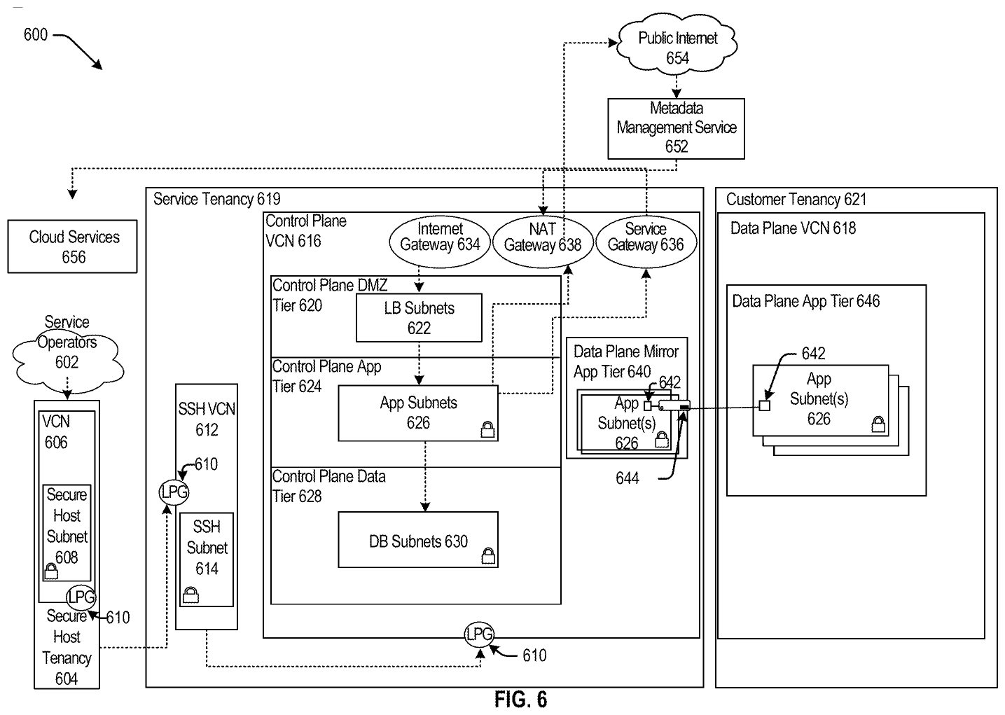

FIG. 6 is a block diagram 600 illustrating another example pattern of an IaaS architecture, according to at least one embodiment. Service operators 602 (e.g. service operators 502 of FIG. 5) can be communicatively coupled to a secure host tenancy 604 (e.g. the secure host tenancy 504 of FIG. 5) that can include a virtual cloud network (VCN) 606 (e.g. the VCN 506 of FIG. 5) and a secure host subnet 608 (e.g. the secure host subnet 508 of FIG. 5). The VCN 606 can include a local peering gateway (LPG) 610 (e.g. the LPG 510 of FIG. 5) that can be communicatively coupled to a secure shell (SSH) VCN 612 (e.g. the SSH VCN 512 of FIG. 5) via an LPG 510 contained in the SSH VCN 612. The SSH VCN 612 can include an SSH subnet 614 (e.g. the SSH subnet 514 of FIG. 5), and the SSH VCN 612 can be communicatively coupled to a control plane VCN 616 (e.g. the control plane VCN 516 of FIG. 5) via an LPG 610 contained in the control plane VCN 616. The control plane VCN 616 can be contained in a service tenancy 619 (e.g. the service tenancy 519 of FIG. 5), and the data plane VCN 618 (e.g. the data plane VCN 518 of FIG. 5) can be contained in a customer tenancy 621 that may be owned or operated by users, or customers, of the system.

The control plane VCN 616 can include a control plane DMZ tier 620 (e.g. the control plane DMZ tier 520 of FIG. 5) that can include LB subnet(s) 622 (e.g. LB subnet(s) 522 of FIG. 5), a control plane app tier 624 (e.g. the control plane app tier 524 of FIG. 5) that can include app subnet(s) 626 (e.g. app subnet(s) 526 of FIG. 5), a control plane data tier 628 (e.g. the control plane data tier 528 of FIG. 5) that can include database (DB) subnet(s) 630 (e.g. similar to DB subnet(s) 530 of FIG. 5). The LB subnet(s) 622 contained in the control plane DMZ tier 620 can be communicatively coupled to the app subnet(s) 626 contained in the control plane app tier 624 and an Internet gateway 634 (e.g. the Internet gateway 534 of FIG. 5) that can be contained in the control plane VCN 616, and the app subnet(s) 626 can be communicatively coupled to the DB subnet(s) 630 contained in the control plane data tier 628 and a service gateway 636 (e.g. the service gateway of FIG. 5) and a network address translation (NAT) gateway 638 (e.g. the NAT gateway 538 of FIG. 5). The control plane VCN 616 can include the service gateway 636 and the NAT gateway 638.

The control plane VCN 616 can include a data plane mirror app tier 640 (e.g. the data plane mirror app tier 540 of FIG. 5) that can include app subnet(s) 626. The app subnet(s) 626 contained in the data plane mirror app tier 640 can include a virtual network interface controller (VNIC) 642 (e.g. the VNIC of 542) that can execute a compute instance 644 (e.g. similar to the compute instance 544 of FIG. 5). The compute instance 644 can facilitate communication between the app subnet(s) 626 of the data plane mirror app tier 640 and the app subnet(s) 626 that can be contained in a data plane app tier 646 (e.g. the data plane app tier 546 of FIG. 5) via the VNIC 642 contained in the data plane mirror app tier 640 and the VNIC 642 contained in the data plane app tier 646.

The Internet gateway 634 contained in the control plane VCN 616 can be communicatively coupled to a metadata management service 652 (e.g. the metadata management service 552 of FIG. 5) that can be communicatively coupled to public Internet 654 (e.g. public Internet 554 of FIG. 5). Public Internet 654 can be communicatively coupled to the NAT gateway 638 contained in the control plane VCN 616. The service gateway 636 contained in the control plane VCN 616 can be communicatively couple to cloud services 656 (e.g. cloud services 556 of FIG. 5).

In some examples, the data plane VCN 618 can be contained in the customer tenancy 621. In this case, the IaaS provider may provide the control plane VCN 616 for each customer, and the IaaS provider may, for each customer, set up a unique compute instance 644 that is contained in the service tenancy 619. Each compute instance 644 may allow communication between the control plane VCN 616, contained in the service tenancy 619, and the data plane VCN 618 that is contained in the customer tenancy 621. The compute instance 644 may allow resources, that are provisioned in the control plane VCN 616 that is contained in the service tenancy 619, to be deployed or otherwise used in the data plane VCN 618 that is contained in the customer tenancy 621.

In other examples, the customer of the IaaS provider may have databases that live in the customer tenancy 621. In this example, the control plane VCN 616 can include the data plane mirror app tier 640 that can include app subnet(s) 626. The data plane mirror app tier 640 can reside in the data plane VCN 618, but the data plane mirror app tier 640 may not live in the data plane VCN 618. That is, the data plane mirror app tier 640 may have access to the customer tenancy 621, but the data plane mirror app tier 640 may not exist in the data plane VCN 618 or be owned or operated by the customer of the IaaS provider. The data plane mirror app tier 640 may be configured to make calls to the data plane VCN 618 but may not be configured to make calls to any entity contained in the control plane VCN 616. The customer may desire to deploy or otherwise use resources in the data plane VCN 618 that are provisioned in the control plane VCN 616, and the data plane mirror app tier 640 can facilitate the desired deployment, or other usage of resources, of the customer.

In some embodiments, the customer of the IaaS provider can apply filters to the data plane VCN 618. In this embodiment, the customer can determine what the data plane VCN 618 can access, and the customer may restrict access to public Internet 654 from the data plane VCN 618. The IaaS provider may not be able to apply filters or otherwise control access of the data plane VCN 618 to any outside networks or databases. Applying filters and controls by the customer onto the data plane VCN 618, contained in the customer tenancy 621, can help isolate the data plane VCN 618 from other customers and from public Internet 654.

In some embodiments, cloud services 656 can be called by the service gateway 636 to access services that may not exist on public Internet 654, on the control plane VCN 616, or on the data plane VCN 618. The connection between cloud services 656 and the control plane VCN 616 or the data plane VCN 618 may not be live or continuous. Cloud services 656 may exist on a different network owned or operated by the IaaS provider. Cloud services 656 may be configured to receive calls from the service gateway 636 and may be configured to not receive calls from public Internet 654. Some cloud services 656 may be isolated from other cloud services 656, and the control plane VCN 616 may be isolated from cloud services 656 that may not be in the same region as the control plane VCN 616. For example, the control plane VCN 616 may be located in “Region 1,” and cloud service “Deployment 6,” may be located in Region 1 and in “Region 2.” If a call to Deployment 6 is made by the service gateway 636 contained in the control plane VCN 616 located in Region 1, the call may be transmitted to Deployment 6 in Region 1. In this example, the control plane VCN 616, or Deployment 6 in Region 1, may not be communicatively coupled to, or otherwise in communication with, Deployment 6 in Region 2.

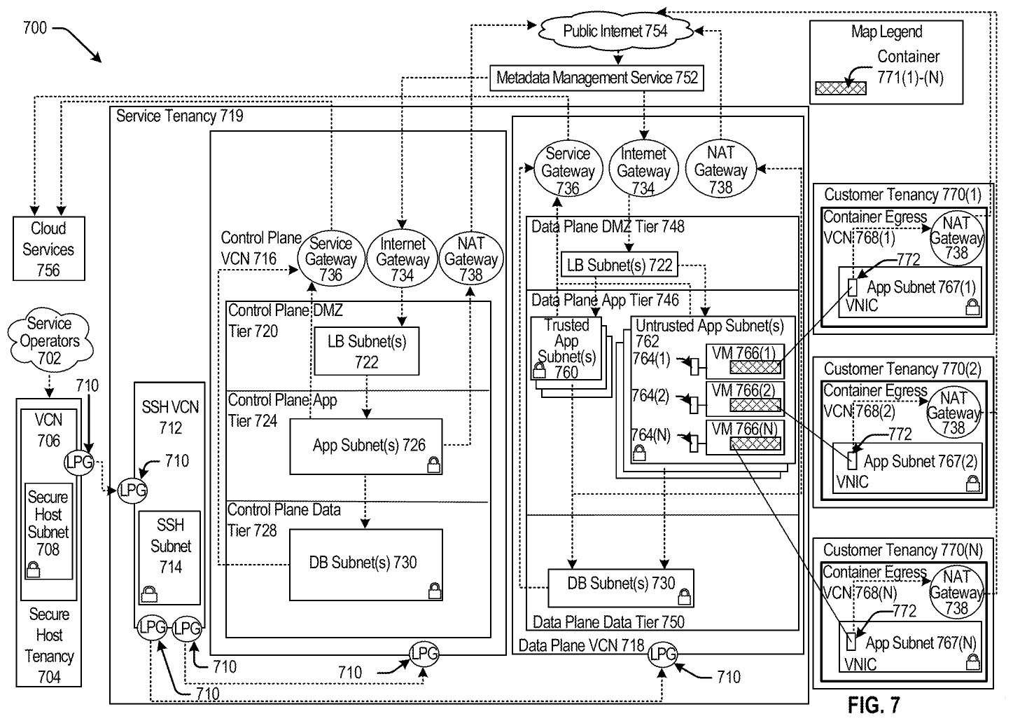

FIG. 7 is a block diagram 700 illustrating another example pattern of an IaaS architecture, according to at least one embodiment. Service operators 702 (e.g. service operators 502 of FIG. 5) can be communicatively coupled to a secure host tenancy 704 (e.g. the secure host tenancy 504 of FIG. 5) that can include a virtual cloud network (VCN) 706 (e.g. the VCN 506 of FIG. 5) and a secure host subnet 708 (e.g. the secure host subnet 508 of FIG. 5). The VCN 706 can include an LPG 710 (e.g. the LPG 510 of FIG. 5) that can be communicatively coupled to an SSH VCN 712 (e.g. the SSH VCN 512 of FIG. 5) via an LPG 710 contained in the SSH VCN 712. The SSH VCN 712 can include an SSH subnet 714 (e.g. the SSH subnet 514 of FIG. 5), and the SSH VCN 712 can be communicatively coupled to a control plane VCN 716 (e.g. the control plane VCN 516 of FIG. 5) via an LPG 710 contained in the control plane VCN 716 and to a data plane VCN 718 (e.g. the data plane 518 of FIG. 5) via an LPG 710 contained in the data plane VCN 718. The control plane VCN 716 and the data plane VCN 718 can be contained in a service tenancy 719 (e.g. the service tenancy 519 of FIG. 5).

The control plane VCN 716 can include a control plane DMZ tier 720 (e.g. the control plane DMZ tier 520 of FIG. 5) that can include load balancer (LB) subnet(s) 722 (e.g. LB subnet(s) 522 of FIG. 5), a control plane app tier 724 (e.g. the control plane app tier 524 of FIG. 5) that can include app subnet(s) 726 (e.g. similar to app subnet(s) 526 of FIG. 5), a control plane data tier 728 (e.g. the control plane data tier 528 of FIG. 5) that can include DB subnet(s) 730. The LB subnet(s) 722 contained in the control plane DMZ tier 720 can be communicatively coupled to the app subnet(s) 726 contained in the control plane app tier 724 and to an Internet gateway 734 (e.g. the Internet gateway 534 of FIG. 5) that can be contained in the control plane VCN 716, and the app subnet(s) 726 can be communicatively coupled to the DB subnet(s) 730 contained in the control plane data tier 728 and to a service gateway 736 (e.g. the service gateway of FIG. 5) and a network address translation (NAT) gateway 738 (e.g. the NAT gateway 538 of FIG. 5). The control plane VCN 716 can include the service gateway 736 and the NAT gateway 738.

The data plane VCN 718 can include a data plane app tier 746 (e.g. the data plane app tier 546 of FIG. 5), a data plane DMZ tier 748 (e.g. the data plane DMZ tier 548 of FIG. 5), and a data plane data tier 750 (e.g. the data plane data tier 550 of FIG. 5). The data plane DMZ tier 748 can include LB subnet(s) 722 that can be communicatively coupled to trusted app subnet(s) 760 and untrusted app subnet(s) 762 of the data plane app tier 746 and the Internet gateway 734 contained in the data plane VCN 718. The trusted app subnet(s) 760 can be communicatively coupled to the service gateway 736 contained in the data plane VCN 718, the NAT gateway 738 contained in the data plane VCN 718, and DB subnet(s) 730 contained in the data plane data tier 750. The untrusted app subnet(s) 762 can be communicatively coupled to the service gateway 736 contained in the data plane VCN 718 and DB subnet(s) 730 contained in the data plane data tier 750. The data plane data tier 750 can include DB subnet(s) 730 that can be communicatively coupled to the service gateway 736 contained in the data plane VCN 718.

The untrusted app subnet(s) 762 can include one or more primary VNICs 764(1)-(N) that can be communicatively coupled to tenant virtual machines (VMs) 766(1)-(N). Each tenant VM 766(1)-(N) can be communicatively coupled to a respective app subnet 767(1)-(N) that can be contained in respective container egress VCNs 768(1)-(N) that can be contained in respective customer tenancies 770(1)-(N). Respective secondary VNICs 772(1)-(N) can facilitate communication between the untrusted app subnet(s) 762 contained in the data plane VCN 718 and the app subnet contained in the container egress VCNs 768(1)-(N). Each container egress VCNs 768(1)-(N) can include a NAT gateway 738 that can be communicatively coupled to public Internet 754 (e.g. public Internet 554 of FIG. 5).

The Internet gateway 734 contained in the control plane VCN 716 and contained in the data plane VCN 718 can be communicatively coupled to a metadata management service 752 (e.g. the metadata management system 552 of FIG. 5) that can be communicatively coupled to public Internet 754. Public Internet 754 can be communicatively coupled to the NAT gateway 738 contained in the control plane VCN 716 and contained in the data plane VCN 718. The service gateway 736 contained in the control plane VCN 716 and contained in the data plane VCN 718 can be communicatively couple to cloud services 756.

In some embodiments, the data plane VCN 718 can be integrated with customer tenancies 770. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 746. Code to run the function may be executed in the VMs 766(1)-(N), and the code may not be configured to run anywhere else on the data plane VCN 718. Each VM 766(1)-(N) may be connected to one customer tenancy 770. Respective containers 771(1)-(N) contained in the VMs 766(1)-(N) may be configured to run the code. In this case, there can be a dual isolation (e.g., the containers 771(1)-(N) running code, where the containers 771(1)-(N) may be contained in at least the VM 766(1)-(N) that are contained in the untrusted app subnet(s) 762), which may help prevent incorrect or otherwise undesirable code from damaging the network of the IaaS provider or from damaging a network of a different customer. The containers 771(1)-(N) may be communicatively coupled to the customer tenancy 770 and may be configured to transmit or receive data from the customer tenancy 770. The containers 771(1)-(N) may not be configured to transmit or receive data from any other entity in the data plane VCN 718. Upon completion of running the code, the IaaS provider may kill or otherwise dispose of the containers 771(1)-(N).

In some embodiments, the trusted app subnet(s) 760 may run code that may be owned or operated by the IaaS provider. In this embodiment, the trusted app subnet(s) 760 may be communicatively coupled to the DB subnet(s) 730 and be configured to execute CRUD operations in the DB subnet(s) 730. The untrusted app subnet(s) 762 may be communicatively coupled to the DB subnet(s) 730, but in this embodiment, the untrusted app subnet(s) may be configured to execute read operations in the DB subnet(s) 730. The containers 771(1)-(N) that can be contained in the VM 766(1)-(N) of each customer and that may run code from the customer may not be communicatively coupled with the DB subnet(s) 730.

In other embodiments, the control plane VCN 716 and the data plane VCN 718 may not be directly communicatively coupled. In this embodiment, there may be no direct communication between the control plane VCN 716 and the data plane VCN 718. However, communication can occur indirectly through at least one method. An LPG 710 may be established by the IaaS provider that can facilitate communication between the control plane VCN 716 and the data plane VCN 718. In another example, the control plane VCN 716 or the data plane VCN 718 can make a call to cloud services 756 via the service gateway 736. For example, a call to cloud services 756 from the control plane VCN 716 can include a request for a service that can communicate with the data plane VCN 718.

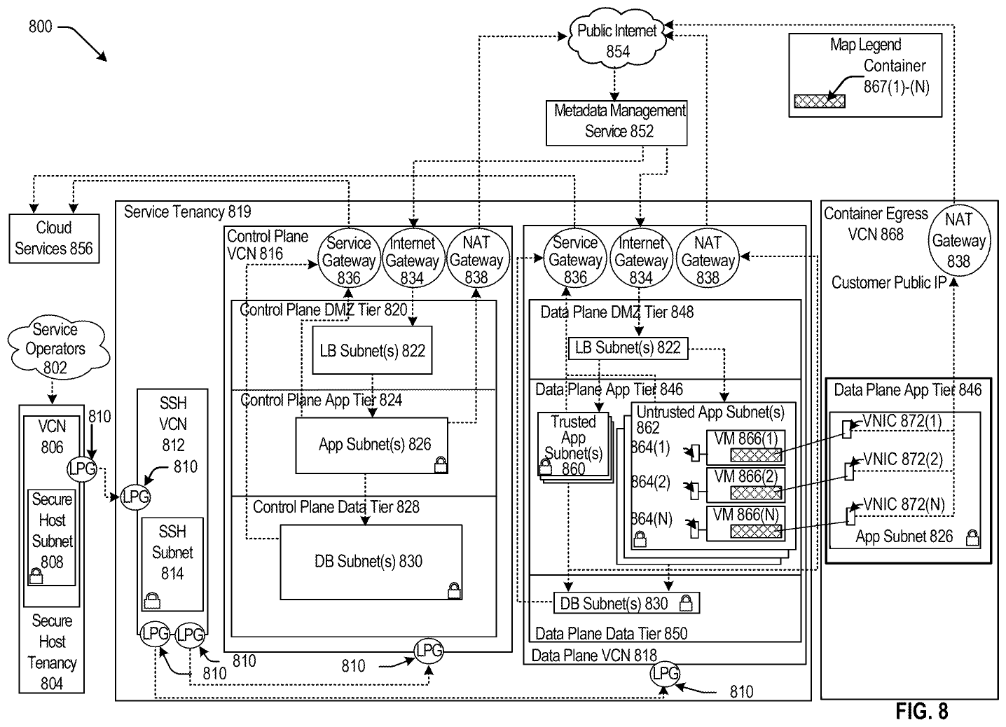

FIG. 8 is a block diagram 800 illustrating another example pattern of an IaaS architecture, according to at least one embodiment. Service operators 802 (e.g. service operators 502 of FIG. 5) can be communicatively coupled to a secure host tenancy 804 (e.g. the secure host tenancy 504 of FIG. 5) that can include a virtual cloud network (VCN) 806 (e.g. the VCN 506 of FIG. 5) and a secure host subnet 808 (e.g. the secure host subnet 508 of FIG. 5). The VCN 806 can include an LPG 810 (e.g. the LPG 510 of FIG. 5) that can be communicatively coupled to an SSH VCN 812 (e.g. the SSH VCN 512 of FIG. 5) via an LPG 810 contained in the SSH VCN 812. The SSH VCN 812 can include an SSH subnet 814 (e.g. the SSH subnet 514 of FIG. 5), and the SSH VCN 812 can be communicatively coupled to a control plane VCN 816 (e.g. the control plane VCN 516 of FIG. 5) via an LPG 810 contained in the control plane VCN 816 and to a data plane VCN 818 (e.g. the data plane 518 of FIG. 5) via an LPG 810 contained in the data plane VCN 818. The control plane VCN 816 and the data plane VCN 818 can be contained in a service tenancy 819 (e.g. the service tenancy 519 of FIG. 5).

The control plane VCN 816 can include a control plane DMZ tier 820 (e.g. the control plane DMZ tier 520 of FIG. 5) that can include LB subnet(s) 822 (e.g. LB subnet(s) 522 of FIG. 5), a control plane app tier 824 (e.g. the control plane app tier 524 of FIG. 5) that can include app subnet(s) 826 (e.g. app subnet(s) 526 of FIG. 5), a control plane data tier 828 (e.g. the control plane data tier 528 of FIG. 5) that can include DB subnet(s) 830 (e.g. DB subnet(s) 730 of FIG. 7). The LB subnet(s) 822 contained in the control plane DMZ tier 820 can be communicatively coupled to the app subnet(s) 826 contained in the control plane app tier 824 and to an Internet gateway 834 (e.g. the Internet gateway 534 of FIG. 5) that can be contained in the control plane VCN 816, and the app subnet(s) 826 can be communicatively coupled to the DB subnet(s) 830 contained in the control plane data tier 828 and to a service gateway 836 (e.g. the service gateway of FIG. 5) and a network address translation (NAT) gateway 838 (e.g. the NAT gateway 538 of FIG. 5). The control plane VCN 816 can include the service gateway 836 and the NAT gateway 838.

The data plane VCN 818 can include a data plane app tier 846 (e.g. the data plane app tier 546 of FIG. 5), a data plane DMZ tier 848 (e.g. the data plane DMZ tier 548 of FIG. 5), and a data plane data tier 850 (e.g. the data plane data tier 550 of FIG. 5). The data plane DMZ tier 848 can include LB subnet(s) 822 that can be communicatively coupled to trusted app subnet(s) 860 (e.g. trusted app subnet(s) 760 of FIG. 7) and untrusted app subnet(s) 862 (e.g. untrusted app subnet(s) 762 of FIG. 7) of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include primary VNICs 864(1)-(N) that can be communicatively coupled to tenant virtual machines (VMs) 866(1)-(N) residing within the untrusted app subnet(s) 862. Each tenant VM 866(1)-(N) can run code in a respective container 867(1)-(N), and be communicatively coupled to an app subnet 826 that can be contained in a data plane app tier 846 that can be contained in a container egress VCN 868. Respective secondary VNICs 872(1)-(N) can facilitate communication between the untrusted app subnet(s) 862 contained in the data plane VCN 818 and the app subnet contained in the container egress VCN 868. The container egress VCN can include a NAT gateway 838 that can be communicatively coupled to public Internet 854 (e.g. public Internet 554 of FIG. 5).

The Internet gateway 834 contained in the control plane VCN 816 and contained in the data plane VCN 818 can be communicatively coupled to a metadata management service 852 (e.g. the metadata management system 552 of FIG. 5) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively couple to cloud services 856.

In some examples, the pattern illustrated by the architecture of block diagram 800 of FIG. 8 may be considered an exception to the pattern illustrated by the architecture of block diagram 600 of FIG. 6 and may be desirable for a customer of the IaaS provider if the IaaS provider cannot directly communicate with the customer (e.g., a disconnected region). The respective containers 867(1)-(N) that are contained in the VMs 866(1)-(N) for each customer can be accessed in real-time by the customer. The containers 867(1)-(N) may be configured to make calls to respective secondary VNICs 872(1)-(N) contained in app subnet(s) 826 of the data plane app tier 846 that can be contained in the container egress VCN 868. The secondary VNICs 872(1)-(N) can transmit the calls to the NAT gateway 838 that may transmit the calls to public Internet 854. In this example, the containers 867(1)-(N) that can be accessed in real-time by the customer can be isolated from the control plane VCN 816 and can be isolated from other entities contained in the data plane VCN 818. The containers 867(1)-(N) may also be isolated from resources from other customers.

In other examples, the customer can use the containers 867(1)-(N) to call cloud services 856. In this example, the customer may run code in the containers 867(1)-(N) that requests a service from cloud services 856. The containers 867(1)-(N) can transmit this request to the secondary VNICs 872(1)-(N) that can transmit the request to the NAT gateway that can transmit the request to public Internet 854. Public Internet 854 can transmit the request to LB subnet(s) 822 contained in the control plane VCN 816 via the Internet gateway 834. In response to determining the request is valid, the LB subnet(s) can transmit the request to app subnet(s) 826 that can transmit the request to cloud services 856 via the service gateway 836.

It should be appreciated that IaaS architectures 500, 600, 700, 800 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

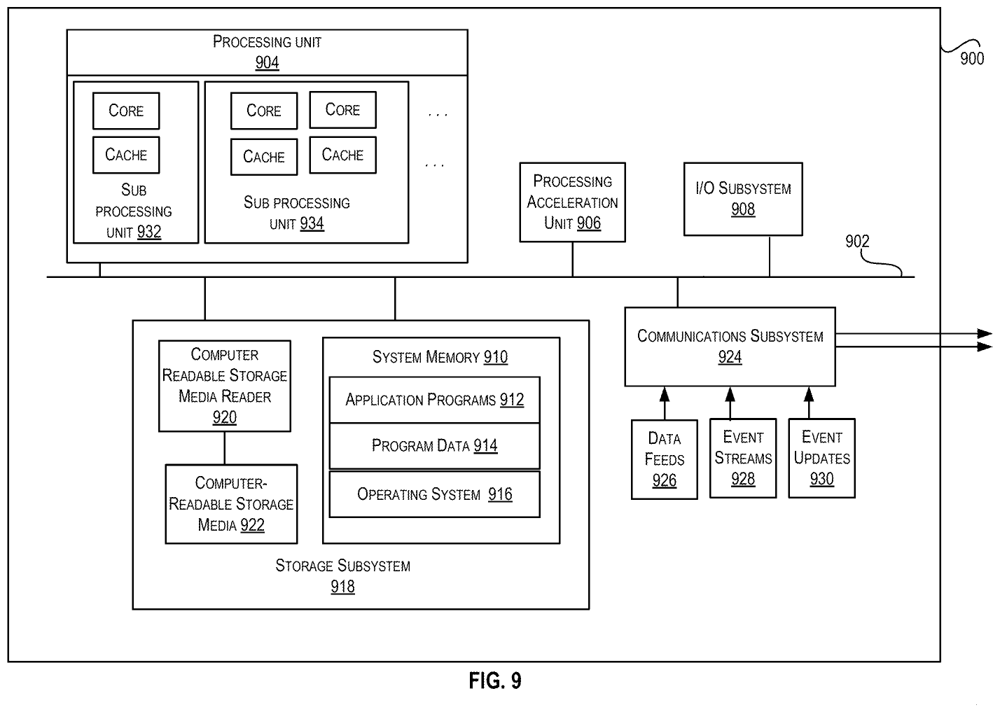

FIG. 9 illustrates an example computer system 900, in which various embodiments may be implemented. The system 900 may be used to implement any of the computer systems described above. As shown in the figure, computer system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible computer-readable storage media 922 and a system memory 910.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of computer system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some or all of the program code to be executed can be resident in processor(s) 904 and/or in storage subsystem 918. Through suitable programming, processor(s) 904 can provide various functionalities described above. Computer system 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 900 may comprise a storage subsystem 918 that comprises software elements, shown as being currently located within a system memory 910. System memory 910 may store program instructions that are loadable and executable on processing unit 904, as well as data generated during the execution of these programs.

Depending on the configuration and type of computer system 900, system memory 910 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 904. In some implementations, system memory 910 may include multiple different types of memory, such as static random access memory (SRAM) or dynamic random access memory (DRAM). In some implementations, a basic input/output system (BIOS), containing the basic routines that help to transfer information between elements within computer system 900, such as during start-up, may typically be stored in the ROM. By way of example, and not limitation, system memory 910 also illustrates application programs 912, which may include client applications, Web browsers, mid-tier applications, relational database management systems (RDBMS), etc., program data 914, and an operating system 916. By way of example, operating system 916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 918 may also provide a tangible computer-readable storage medium for storing the basic programming and data constructs that provide the functionality of some embodiments. Software (programs, code modules, instructions) that when executed by a processor provide the functionality described above may be stored in storage subsystem 918. These software modules or instructions may be executed by processing unit 904. Storage subsystem 918 may also provide a repository for storing data used in accordance with the present disclosure.

Storage subsystem 900 may also include a computer-readable storage media reader 920 that can further be connected to computer-readable storage media 922. Together and, optionally, in combination with system memory 910, computer-readable storage media 922 may comprehensively represent remote, local, fixed, and/or removable storage devices plus storage media for temporarily and/or more permanently containing, storing, transmitting, and retrieving computer-readable information.

Computer-readable storage media 922 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 900.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 1000 to connect to one or more devices via the Internet. In some embodiments communications subsystem 924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 924 may also be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method comprising:
responsive to a request received by an application migration service (AMS) to migrate an application executed in a first compute instance in a source cloud environment to a second compute instance in a target cloud environment, authenticating by the AMS, credentials of a user with respect to the source cloud environment; and
responsive to the credentials of the user being successfully authenticated:
generating, by the AMS, a pair of keys including a public key and a private key;
transmitting, by the AMS, the public key to a service manager, the service manager being configured for injecting the public key in the application executed in the first compute instance of the source cloud environment;
assigning, by the AMS, the private key to a source agent deployed in the source cloud environment;
obtaining, by the source agent, one or more artifacts and configuration information that enable execution of the application based on the private key; and
installing, by a target agent deployed in the target cloud environment, the one or more artifacts and the configuration information in the second compute instance.

2. The method of claim 1, wherein the first compute instance is deployed in a customer tenancy of the source cloud environment, and the source agent is deployed in a service tenancy of the source cloud environment, the customer tenancy being different than the service tenancy.

3. The method of claim 1, wherein the second compute instance is deployed in a customer tenancy of the target cloud environment, and the target agent is deployed in a service tenancy of the target cloud environment, the customer tenancy being different than the service tenancy.

4. The method of claim 1, wherein the pair of keys is ephemeral and associated with the request.

5. The method of claim 1, wherein injecting, by the service manager, the public key in the application corresponds to storing the public key in an authorized key file associated with the application.

6. The method of claim 1, wherein each of the first compute instance and the second compute instance is a virtual machine.

7. The method of claim 1, wherein authenticating by the AMS further comprises:
encrypting the credentials of the user based on a key to generate an encrypted credential;
storing the encrypted credential in a key-value database; and
generating an asynchronous work request to validate the credentials.

8. The method of claim 7, further comprising:
processing, by the service manager, the asynchronous work request by decrypting, encrypted credentials based on the key; and
verifying, by the service manager, a validity of a decrypted credential of the user and determining a level of privilege associated with the user.

9. The method of claim 2, further comprising:
selecting the source agent from a pool of source agents deployed in the service tenancy of the source cloud environment;
storing, by the source agent, the one or more artifacts and the configuration information in an encrypted database; and
responsive to storing the one or more artifacts and the configuration information in the encrypted database, releasing the source agent to the pool of source agents.

10. The method of claim 3, further comprising:
reserving the target agent from a pool of target agents deployed in the service tenancy of the target cloud environment;
instantiating the second compute instance in the customer tenancy of the target cloud environment;
obtaining, by the target agent, the one or more artifacts and the configuration information from an encrypted database; and
responsive to completion of installation of the one or more artifacts and the configuration information in the second compute instance by the target agent, releasing the target agent to the pool of target agents.

11. The method of claim 1, further comprising:
creating, by the AMS, a virtual network interface card (VNIC) to be associated with the target agent, wherein the one or more artifacts and the configuration information are installed by the target agent in the second compute instance via the VNIC.

12. The method of claim 1, wherein the application to be migrated from the source cloud environment to the target cloud environment is a platform-as-a-service application.

13. A computer readable medium storing specific computer-executable instructions that, when executed by a processor, cause a computer system to at least:
responsive to a request received by an application migration service (AMS) to migrate an application executed in a first compute instance in a source cloud environment to a second compute instance in a target cloud environment, authenticate by the AMS, credentials of a user with respect to the source cloud environment; and
responsive to the credentials of the user being successfully authenticated:
generate, by the AMS, a pair of keys including a public key and a private key;
transmit, by the AMS, the public key to a service manager, the service manager being configured for injecting the public key in the application executed in the first compute instance of the source cloud environment;
assign, by the AMS, the private key to a source agent deployed in the source cloud environment;
obtain, by the source agent, one or more artifacts and configuration information that enable execution of the application based on the private key; and
install, by a target agent deployed in the target cloud environment, the one or more artifacts and the configuration information in the second compute instance.

14. The computer readable medium of claim 13, wherein the first compute instance is deployed in a customer tenancy of the source cloud environment, and the source agent is deployed in a service tenancy of the source cloud environment, the customer tenancy being different than the service tenancy.

15. The computer readable medium of claim 13, wherein the second compute instance is deployed in a customer tenancy of the target cloud environment, and the target agent is deployed in a service tenancy of the target cloud environment, the customer tenancy being different than the service tenancy.

16. The computer readable medium of claim 13, wherein the computer system is further configured to:
encrypt the credentials of the user based on a key to generate an encrypted credential;
save the encrypted credential in a key-value database; and
generate an asynchronous work request to validate the credentials.

17. The computer readable medium of claim 16, wherein the computer system is further configured to:
execute the asynchronous work request by decrypting, encrypted credentials based on the key; and
verify a validity of a decrypted credential of the user and determining a level of privilege associated with the user.

18. The computer readable medium of claim 13, wherein the computer system is further configured to:
create, by the AMS, a virtual network interface card (VNIC) to be associated with the target agent, wherein the one or more artifacts and the configuration information are installed by the target agent in the second compute instance via the VNIC.

19. The computer readable medium of claim 13, wherein the application to be migrated from the source cloud environment to the target cloud environment is a platform-as-a-service application.

20. A computing device comprising:
a processor; and
a memory including instructions that, when executed with the processor, cause the computing device to, at least:
responsive to a request received by an application migration service (AMS) to migrate an application executed in a first compute instance in a source cloud environment to a second compute instance in a target cloud environment, authenticate by the AMS, credentials of a user with respect to the source cloud environment; and
responsive to the credentials of the user being successfully authenticated:
generate, by the AMS, a pair of keys including a public key and a private key;
transmit, by the AMS, the public key to a service manager, the service manager being configured for injecting the public key in the application executed in the first compute instance of the source cloud environment;
assign, by the AMS, the private key to a source agent deployed in the source cloud environment;
obtain, by the source agent, one or more artifacts and configuration information that enable execution of the application based on the private key; and
install, by a target agent deployed in the target cloud environment, the one or more artifacts and the configuration information in the second compute instance.
